(19) United States
(12) Patent Application Publication
(10) Pub. No.: US 2024/0290302 A1
(43) Pub. Date: Aug. 29, 2024

(54) REED, MOUTHPIECE AND BLOWING PART

(71) Applicant: YAMAHA CORPORATION, Hamamatsu-shi (JP)

(72) Inventors: Katsuya UCHIDA, Iwata-shi (JP); Tetsuro SHOJI, Iwata-shi (JP)

(21) Appl. No.: 18/655,618

(22) Filed: May 6, 2024

Related U.S. Application Data
(63) Continuation of application No. PCT/JP2022/040484, filed on Oct. 28, 2022.

(30) Foreign Application Priority Data
Nov. 11, 2021 (JP) 2021-184399

(51) Int. Cl. G10D 9/035; G10D 9/08

(52) U.S. Cl. CPC G10D 9/035; G10D 9/08

(57) ABSTRACT

In an embodiment, the reed 10 includes a base part 150 and a vamp 153. The base part 150 has a planar portion 151 and a heel 157 at a first end of the base part 150. The vamp 153 extends from a second end of the base part 150, opposite the heel 157. The vamp 153 includes a sloping shape ending in a tip 100 which is inclined relative to the planar portion 151 when the vamp 153 is viewed from the planar portion 151.

### CROSS-REFERENCE TO RELATED APPLICATIONS

This application is a Continuation of International Patent Application No. PCT/JP2022/040484, filed on Oct. 28, 2022, which claims the benefit of priority to Japanese Patent Application No. 2021-184399, filed on Nov. 11, 2021, the entire contents of which are incorporated herein by reference.

### FIELD

The present disclosure relates to a reed and a mouthpiece of a wind instrument.

### BACKGROUND

A reed attached to the mouthpiece of a wind instrument is formed by a plant material commonly referred to as canes. In recent years, a reed formed of a resin material has also been developed (for example, Japanese Laid-Open Patent Publication No. 2008-197450 and U.S. Patent Publication No. 6087571).

### SUMMARY

According to an embodiment, a reed including a base part and a vamp is provided. The base part has a planar portion and a heel at a first end of the base part. The vamp extends from the second end of the base part, opposite the heel. The vamp has a sloping shape ending in a tip, which is inclined relative to the planar portion, when the vamp is viewed along a first direction from the first end to the second end of the base part with the planar portion facing upward.

The sloping shape may be such that an end of the tip is located above a center of the tip when the vamp is viewed along the first direction.

The sloping shape may be symmetrical relative to the center of the tip when the vamp is viewed along the first direction.

The sloping shape may be such that a curve connects two ends of the tip when the vamp is viewed along the first direction.

The curve may have at least one inflection point.

The sloping shape may have a curve that is convex upward at its most upward point when the vamp is viewed along the first direction.

A lowest portion of the tip may be located above the planar portion when the vamp is viewed along the first direction.

The base part and the vamp may include a resin material.

According to an embodiment, a mouthpiece including a table, a side rail, and a tip rail is provided. The side rail extends from the table and has a first end and a second end opposite to the first end. The tip rail extends from the second end the side rail. The first end of the side rail connects the table. The tip rail has a sloping shape inclined relative to the table, when the tip rail is viewed along a first direction from the first end to the second end of the side rail with the table facing upward.

The sloping shape may be such that an end of the tip rail is located above a center of the tip rail when the tip rail is viewed along the first direction.

The sloping shape may be symmetrical relative to the center of the tip rail when the tip rail is viewed along the first direction.

The sloping shape may be such that a curve connects two ends of the tip rail when the tip rail is viewed along the first direction.

The curve may have at least one inflection point.

The sloping shape may have a curve that is convex upward at its most upward point when the tip rail is viewed along the first direction.

According to an embodiment, a blowing part including a reed and a mouthpiece is provided. The reed has a tip. The mouthpiece has a tip rail. A first distance between the tip and the tip rail at a first position near a center of the tip along a width direction, is different from a second distance between the tip and the tip rail at a second position near an end of the tip along the width direction.

According to an embodiment, a blowing part comprising a reed according to any of the above and a mouthpiece according to any of the above is provided. The reed further includes a base part having a planar portion. The mouthpiece further includes a table. The planar potion of the reed is in contact with the table.

### BRIEF DESCRIPTION OF DRAWINGS

FIG. 1 is a diagram showing a blowing part in a first embodiment.

FIG. 2 is a diagram showing a reed and a mouthpiece in the first embodiment.

FIG. 3 is a diagram of a tip in the first embodiment as viewed from a side (corresponding to a direction AR1).

FIG. 4 is a diagram of the tip in the first embodiment as viewed from a tip side (corresponding to a direction AR2).

FIG. 5 is a diagram of a tip rail in the first embodiment as viewed from a tip side (corresponding to a direction AR3).

FIG. 6 is a diagram for explaining a variation in a positional relationship between the tip rail and the tip when the reed in the first embodiment vibrates.

FIG. 7 is a diagram for explaining a shape of a conventional tip.

FIG. 8 is a diagram for explaining a variation in a positional relationship between the tip rail and the tip when a conventional resin-derived reed vibrates.

FIG. 9 is a diagram showing a change in an opening cross-sectional area when the reed vibrates.

FIG. 10 is a diagram showing a blowing part in a second embodiment.

FIG. 11 is a diagram showing a reed and a mouthpiece in the second embodiment.

FIG. 12 is a diagram of a tip rail in the second embodiment viewed from a side (corresponding to a direction AR4).

FIG. 13 is a diagram of the tip rail in the second embodiment as viewed from a rear end side (corresponding to a direction AR5).

FIG. 14 is a diagram for explaining a variation in a positional relationship between the tip rail and the tip when the reed in the second embodiment vibrates.

FIG. 15 is a diagram showing a blowing part in a third embodiment.

FIG. 16 is a diagram for explaining a relationship between a tip rail and a tip in the third embodiment.

FIG. 17 is a diagram for explaining a relationship between a tip rail and a tip in a modified example.

FIG. 18 is a diagram for explaining the relationship between the tip rail and the tip in the modified example.

FIG. 19 is a diagram for explaining the relationship between the tip rail and the tip in the modified example.

FIG. 20 is a diagram for explaining the relationship between the tip rail and the tip in the modified example.

FIG. 21 is a diagram for explaining the relationship between the tip rail and the tip in the modified example.

FIG. 22 is a diagram for explaining the relationship between the tip rail and the tip in the modified example.

FIG. 23 is a diagram for explaining the relationship between the tip rail and the tip in the modified example.

FIG. 24 is a diagram for explaining the relationship between the tip rail and the tip in the modified example.

### DESCRIPTION OF EMBODIMENTS

Sound generated by a reed formed of a resin material (hereinafter, referred to as a resin-derived reed) tends to include more high-order harmonics than sound generated by a reed formed of a plant material (plant-derived reed). For this reason, it is desired to realize various tones by the resin-derived reed, including making the sound generated by the resin-derived reed closer to the sound generated by the plant-derived reeds.

According to the present disclosure, various tones can be realized by a reed formed of a material other than plant materials.

Hereinafter, an embodiment of the present disclosure will be described in detail with reference to the drawings. The following embodiments are examples, and the present disclosure should not be construed as being limited to these embodiments. In the drawings referred to in the present embodiment, the same or similar parts are denoted by the same reference signs or similar reference signs (only denoted by A, B, or the like after the numerals), and repetitive description thereof may be omitted. In the drawings, dimensional ratios may be different from actual ratios, or a part of the configuration may be omitted from the drawings for clarity of explanation.

In an embodiment, a blowing part is, for example, a single-reed blowing part used in a saxophone, and includes a reed formed of resin materials and a mouthpiece. Although the reed may be formed of a material other than the resin materials, for example, metal or ceramics such as an inorganic material, the reed is formed of a material different from a plant-derived reed commonly used in the related art. In the blowing part of an embodiment, a shape of an opening portion (also referred to as “tip opening”) formed between a tip and a tip rail is different from that of a conventional blowing part.

According to a plurality of embodiments described below, a shape of at least one of a tip and a tip rail is different from the conventional shape, whereby an opening portion different from the conventional shape is realized. In a first embodiment, an example in which a tip has a shape different from the conventional shape will be described. In a second embodiment, an example in which a tip rail has a shape different from the conventional shape will be described. In a third embodiment, an example in which a tip and a tip rail have shapes different from those of the conventional shapes will be described.

### [First Embodiment]

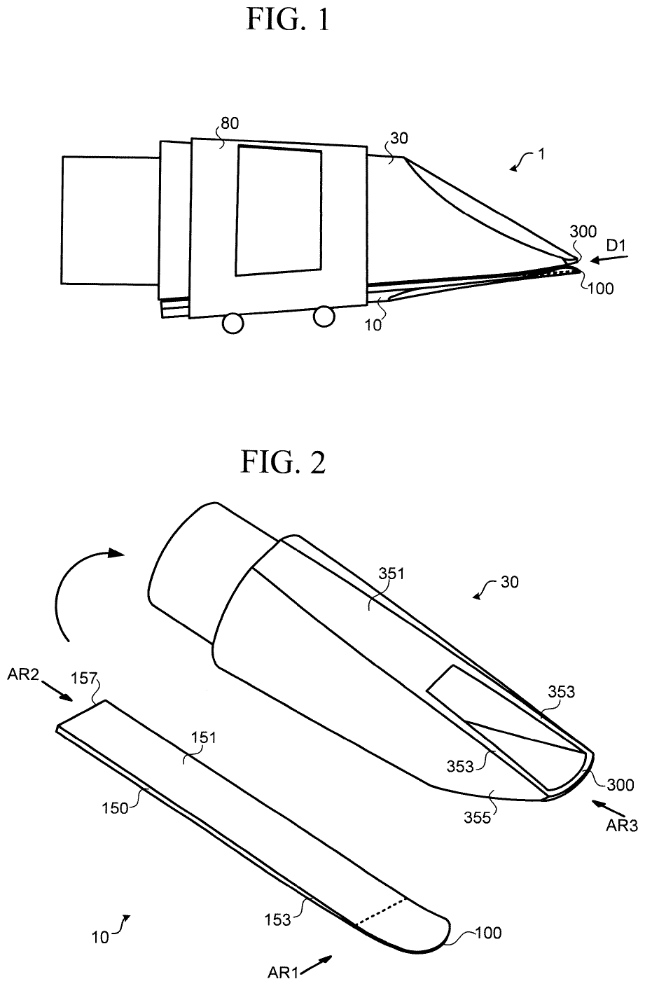

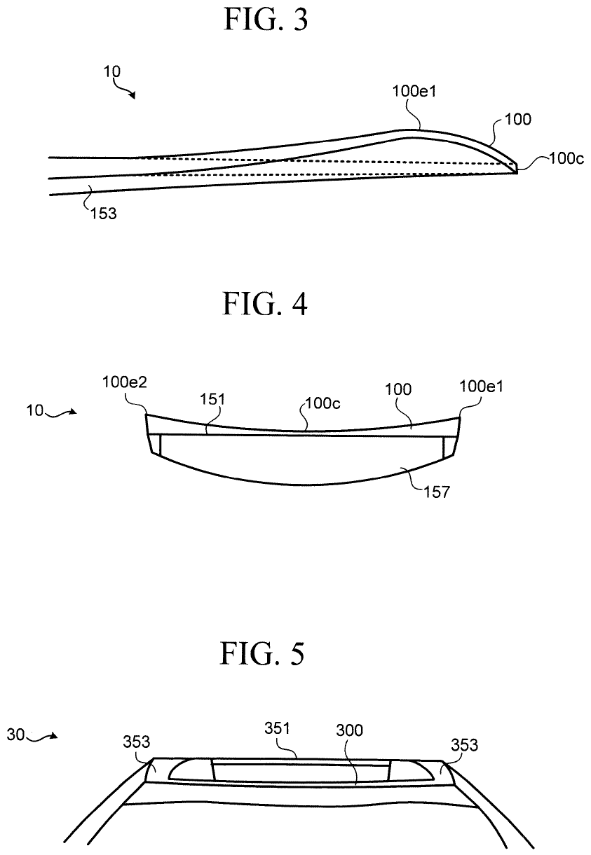

FIG. 1 is a diagram showing a blowing part according to the first embodiment. FIG. 1 shows an example in which the blowing part is viewed from a side. FIG. 2 is a diagram showing a reed and a mouthpiece of the first embodiment. FIG. 3 is a diagram of the tip (part) of the first embodiment viewed from a side (corresponding to a direction AR1). FIG. 4 is a diagram of the tip of the first embodiment as viewed from a tip side (corresponding to a direction AR2).

FIG. 5 is a diagram of a tip rail of the first embodiment as viewed from the tip side (corresponding to a direction AR3).

A blowing part 1 includes a reed 10, a mouthpiece 30, and a ligature 80. The ligature 80 is a member that fixes the reed 10 and the mouthpiece 30. The mouthpiece 30 includes a table 351, a side rail 353, a baffle 355, and a tip rail 300. Two side rails 353 extend from the table 351. The side rail 353 has a first end and a second end opposite to the first end. The first end of the side rail 353 connects the table 351. The tip rail 300 extends from the second end of each of the two side rails 353. At an end of the baffle 355, the tip rail 300 and the side rail 353 are arranged.

When the mouthpiece 30 is viewed in parallel with a front surface of the table 351 and from the tip rail 300 side with the table 351 facing upward (corresponding to the direction AR3 in FIG. 2), as shown in FIG. 5, a tip of the tip rail 300 is a straight line substantially parallel to a plane formed by the table 351. Tip rail 300 is substantially planar and slopes in a direction similar to a direction in which side rail 353 slopes relative to the surface of table 351. That is, when the mouthpiece 30 is viewed from the side in a same manner as in FIG. 1, a surface of the tip rail 300 is inclined relative to the surface of the table 351.

On the other hand, in the tip rail 300, when the mouthpiece 30 is viewed as shown in FIG. 5, it can be said that the surface (in particular, the tip) of the tip rail 300 does not have a portion that is substantially inclined relative to the surface of the table 351. When the mouthpiece 30 is viewed parallel to the surface of the tip rail 300 and from the tip rail 300 (corresponding to a direction D1 in FIG. 1), the tip of the tip rail 300 is recognized as a straight line parallel to the surface of the table 351.

The reed 10 includes a base part 150 and a vamp 153. The base part 150 includes a planar portion 151 and a heel 157. A heel 157 is arranged at a first end of the base part 150. The planar portion 151 is arranged on at least one surface of the base part 150. In this example, the planar portion 151 corresponds to at least a portion of a plane that contacts the table 351 when the reed 10 is attached to the mouthpiece 30. The vamp 153 extends from a second end of the base part 150, opposite the heel 157. That is, the vamp 153 is arranged at one end in a longitudinal direction of the reed 10, and is a portion whose thickness gradually decreases toward the end. A tip of the vamp 153 is a tip 100.

When the vamp 153 is viewed from a side with the planar portion 151 facing upward (corresponding to the direction AR1 in FIG. 2), as shown in FIG. 3, a portion of the vamp 153 (particularly, both ends in a width direction) is bent upward. According to this configuration, as shown in FIG. 4, an end 100e1 and an end 100e2 of the tip 100 are located above a center 100c of the tip 100. A dashed line shown in the portion of the vamp 153 in FIG. 2 corresponds to a position where an upper surface of the vamp 153 is not parallel to the planar portion 151 due to the bent shape.

When the vamp 153 is viewed from the planar portion 151 with the planar portion 151 facing upward (corresponding to the direction AR2 in FIG. 2), as shown in FIG. 4, the tip 100 includes a sloping shape inclined relative to the planar portion 151. Here, the direction AR2 can be said to be a direction (a first direction) along from the first end to the second end of the base part 150. When the tip 100 is viewed as shown in FIG. 4, the tip 100 in this example has the following features.

The tip 100 is connected by a curve between the end 100e1 and the end 100e2. The ends 100e1 and 100e2 of the tip 100 are located above the center 100c of the tip 100. The tip 100 is symmetrical relative to the center 100c. The lowermost center 100c of the tip 100 is located above the planar portion 151. The lowermost portion (the center 100c) of the tip 100 may be located below the planar portion 151, or the uppermost portion (ends 100e1 and 100e2) may be located below the planar portion 151. The above is the description of the configuration of the blowing part 1.

Next, sound generation in the case of using the blowing part 1 described above will be described. First, a situation when the reed 10 vibrates will be described.

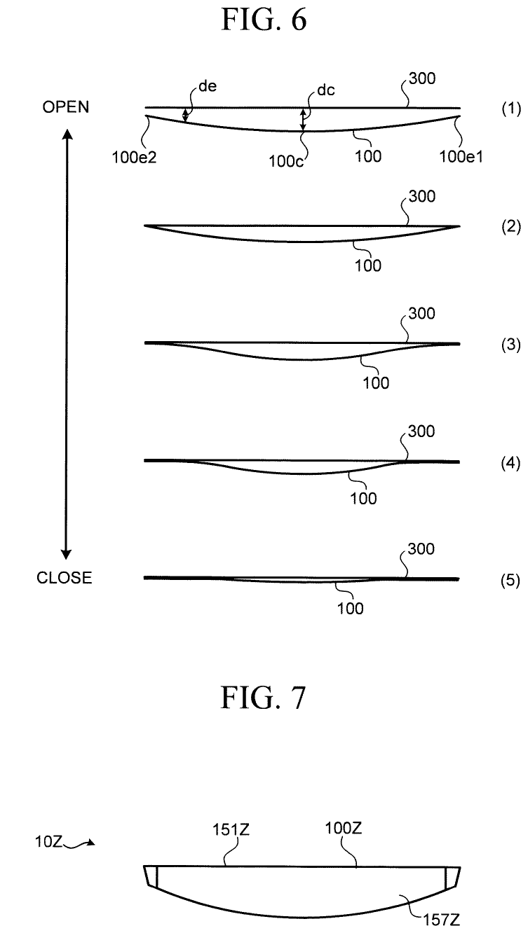

FIG. 6 is a diagram for explaining a variation in a positional relationship between the tip rail and the tip when the reed of the first embodiment vibrates. The tip rail 300 and the tip 100 shown in FIG. 6 show a positional relationship when the blowing part 1 is viewed from the tip (corresponding to the direction D1 in FIG. 1). The direction D1 is a direction along the surface of the tip rail 300, and is a direction in which the tip rail 300A appears as a straight line. A gap between the tip rail 300 and the tip 100 corresponds to an opening portion (tip opening). FIG. 6 shows positional relationships between the tip 100 and the tip rail 300 at five timings (timings (1) to (5)) when the reed 10 vibrates.

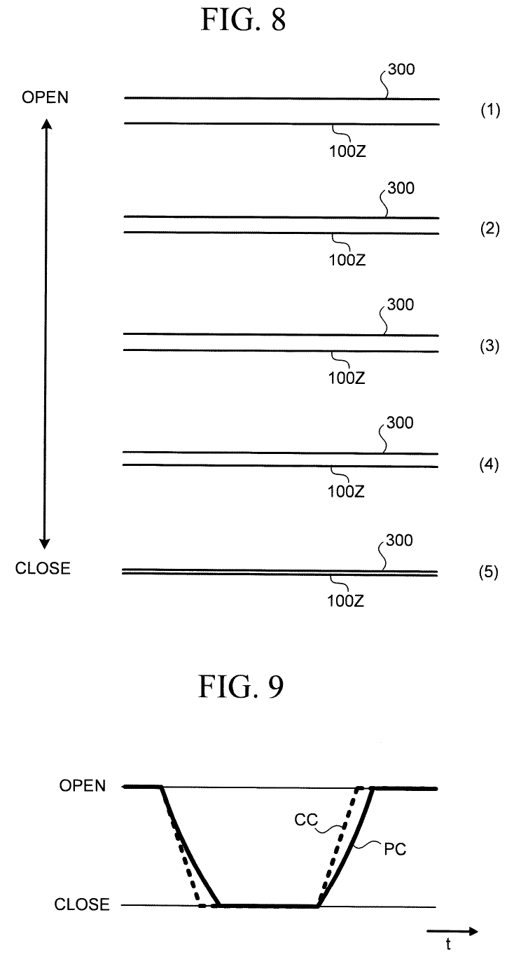

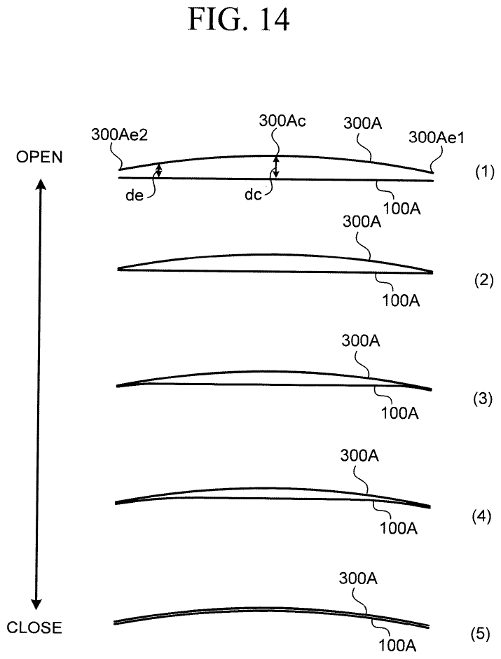

At the timing (1), the opening portion is open (OPEN), and at the timing (5), the opening portion is closed (CLOSE). In some cases, the state indicated by the timing (1) is a state in which the opening portion is not the most open. In an initial state in which the reed 10 is attached to the mouthpiece 30, the state may be the timing (1) state, or may be another timing state such as the timing (2). FIG. 8 and FIG. 14 described below are same as FIG. 6.

In the case at the timing (1), a distance dc (first distance) from the tip 100 to the tip rail 300 at the center 100c (first position) is the largest, and a distance de (second distance) from the tip 100 to the tip rail 300 in a vicinity (second position) of the ends 100e1 and 100e2 is smaller than the distance dc. In other words, there are two positions where the distance between the tip 100 and the tip rail 300 differs from each other.

According to such a configuration, as shown in FIG. 6, the tip 100 and the tip rail 300 first come into contact with each other at a portion where the tip 100 and the tip rail 300 are close to each other (in this embodiment, the ends 100e1 and 100e2). Thereafter, a distance between the tip rail 300 and a tip 100 at the center 100c gradually decreases, and the tip 100 and the tip rail 300 finally come into contact with each other at the center 100c.

Therefore, the smaller an area of the opening portion (hereinafter referred to as an opening cross-sectional area), the smaller a temporal variation (temporal derivative) of the opening cross-sectional area per unit time. In other words, the smaller a maximum distance between the tip 100 and the tip rail 300, the smaller the temporal variation.

For comparison, a positional relationship between the tip rail and the tip in the case of a conventional resin-derived reed having a flat plate shape will also be described.

FIG. 7 is a diagram for explaining a shape of a conventional tip. FIG. 7 shows a conventional resin-derived reed 10Z viewed in the same direction as in FIG. 4, that is, the reed 10Z viewed from a heel 157Z with a planar portion 151Z facing upward. As shown in FIG. 7, a tip 100Z is on the same plane as the planar portion 151Z. In this way, the conventional resin-derived reed 10Z has a flat plate shape extending to the tip 100Z.

FIG. 8 is a diagram showing a variation in the positional relationship between the tip rail and the tip when the conventional resin-derived reed vibrates. As shown in FIG. 8, a distance between the tip 100Z and the tip rail 300 in the conventional reed 10Z is substantially the same at any position. Therefore, there is almost no situation in which the tip 100Z and the tip rail 300 partially contact with each other during the vibration of the reed 10Z. Therefore, a temporal variation of an opening cross-sectional area per unit time when the opening cross-sectional area becomes smaller is larger than that of the example of FIG. 6. The temporal variation of the opening cross-sectional area will be further described by comparing the situation of FIG. 6 with the situation of FIG. 8.

FIG. 9 is a diagram showing the variation in the opening cross-sectional area when the reed vibrates. In FIG. 9, a waveform PC showing the variation in the opening cross-sectional area when the reed 10 vibrates and a waveform CC showing a variation in the opening cross-sectional area when the reed 10Z vibrates are shown by broken lines. In FIG. 9, only one opening and closing is shown. The waveform PC has a gradual variation in a part close to the closed state (CLOSE) as compared with the waveform CC. This gradual variation indicates that high-order harmonic components are attenuated in the waveform

PC compared to the waveform CC. Since the variation in the opening cross-sectional area corresponds to sounds generated inside the blowing part 1, according to the blowing part 1 using the reed 10, the high-order harmonic components are less than high-order harmonic components in the blowing part using the reed 10Z, and a soft sound is generated.

Here, a conventional plant-derived reed generally has the same flat plate shape as the reed 10Z. In the case where the plant-derived reed vibrates, a relationship between a tip and a tip rail was thought to vary as shown in FIG. 8. Actually, when vibration of the reed starts at the timing (1) in FIG. 8, it was confirmed by an investigation of the inventors that both ends of the tip are deformed during the vibration so as to approach the tip rail from both ends of the tip. That is, when the vibration of the reed started, it was confirmed that the variation in the opening cross-sectional area corresponds to the variation shown in FIG. 6 by varying the positional relationship of the timing (1) shown in FIG. 8 to the positional relationship of the timing (1) shown in FIG. 6.

As described above, it was confirmed that, in the case of the plant-derived reed, the vibration shown in FIG. 8 is not performed even if the shape is same as the reed 10Z, and the vibration is similar to the vibration shown in FIG.

6 during the vibration. It is considered that such a phenomenon occurs because the mechanical properties such as Young's modulus have anisotropy due to an orientation of plant fibers contained in the material of the reed.

It is not easy to form a reed having mechanical properties such as a plant-derived reed with a material different from that of the plant-derived reed.

However, according to the blowing part 1 in one embodiment, even if a reed made of a material having mechanical properties that does not have anisotropy is used, by setting a shape of at least one of the tip 100 and the tip rail 300 such that the distance between the tip 100 and the tip rail 300 varies depending on positions in the width direction, it is possible to suppress high-order harmonic components and make sound closer to sound generated by the plant-derived reed. Further, the high-order harmonic components can be adjusted by variously setting a relationship between the distance between the tip 100 and the tip rail 300 and the position in the width direction. As a result, various tones can also be realized.

### [Second Embodiment]

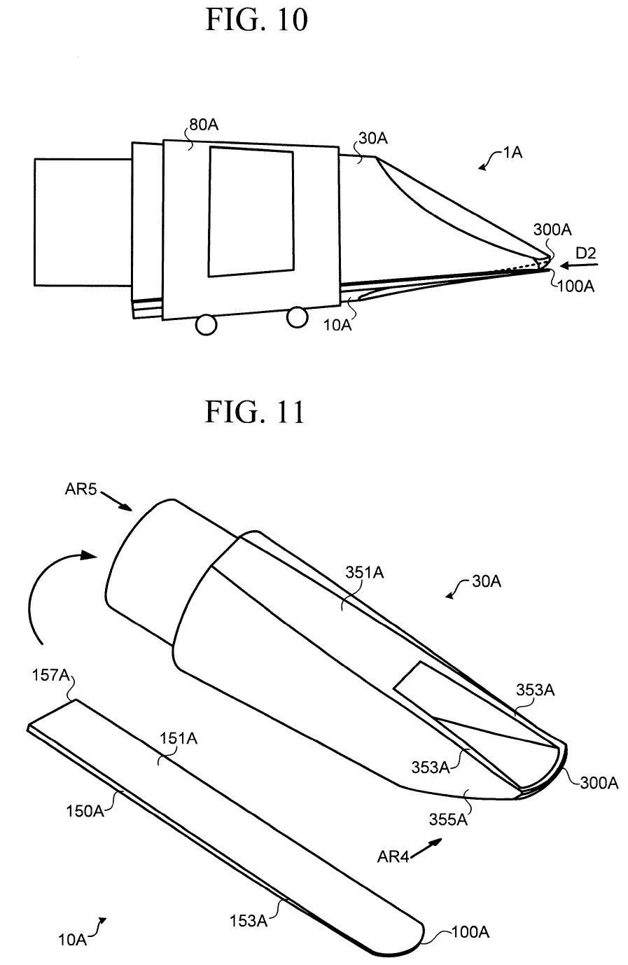

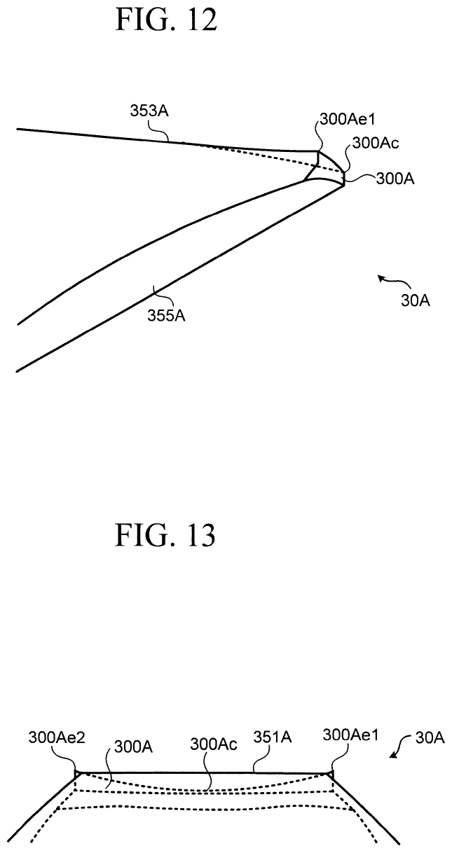

FIG. 10 is a diagram showing a blowing part according to the second embodiment. FIG. 11 is a diagram showing a reed and a mouthpiece in the second embodiment. FIG. 12 is a view of a tip rail of the second embodiment viewed from a side (corresponding to a direction AR4). FIG. 13 is a view of a tip rail of the second embodiment as viewed from a rear end side (corresponding to a direction AR5).

A blowing part 1A includes a reed 10A, a mouthpiece 30A, and a ligature 80A. The ligature 80A is the same as the ligature 80. The reed 10A includes a base part 150A and a vamp 153A. The reed 10A is the same as the conventional reed 10Z described above. That is, when the vamp 153A is viewed from a planar portion 151A with the planar portion 151A facing upward, same as in the tip 100Z shown in FIG. 7, a tip 100A of a tip of the vamp 153A is formed flat without being inclined relative to the planar portion 151A. Therefore, a surface of the reed 10A on the planar portion 151A side forms a plane from a heel 157A to the tip 100A.

The mouthpiece 30A includes a table 351A, a side rail 353A, a baffle 355A, and a tip rail 300A. When the mouthpiece 30A is viewed from a side with the table 351A facing upward (corresponding to the direction AR4 in FIG. 11), as shown in FIG. 12, a part of a surface of the tip rail 300A and a part of a surface of the side rail 353A (in particular, both ends in a width direction) are bent upward. According to this shape, as shown in FIG. 13, an end 300Ae1 and an end 300Ae2 of the tip rail 300A are positioned on an upper side relative to a center 300Ac of the tip rail 300A.

As shown in FIG. 13, when the tip rail 300A is viewed from the table 351A with the table 351A facing upward (corresponding to the direction AR5 in FIG. 11), the tip rail 300A includes a sloping shape inclined relative to the table 351A. Here, the direction AR5 can be said to be a direction (a first direction) along from the first end to the second end of the side rail 353A. The tip rail 300A in this embodiment has the following features.

The end 300Ae1 and the end 300Ae2 of the tip rail 300A are connected by a curve. The ends 300Ae1 and 300Ae2 of the tip rail 300A are located above the center 300Ac of the tip rail 300A. The tip rail 300A is symmetrical relative to the center 300Ac.

Next, sound generated when using the blowing part 1A described above will be described.

FIG. 14 is a diagram for explaining a variation in a positional relationship between the tip rail and the tip when the reed of the second embodiment vibrates. The tip rail 300A and the tip 100A shown in FIG. 14 show a positional relation when the blowing part 1A is viewed from the tip in FIG. 10 (corresponding to a direction D2 in FIG. 10). The direction D2 is a direction along the planar portion 151A, and is a direction in which the tip 100A appears as a straight line.

Also in the blowing part 1A, in the case of the timing (1), a distance dc between the tip 100A and the tip rail 300A at the center 300Ac is the largest, and a distance de between the tip 100A and the tip rail 300A in a vicinity of the ends 300Ae1 and 300Ae2 is smaller than the distance dc. In other words, there are two positions where the distance between the tip 100A and the tip rail 300A differs from each other.

According to such a configuration, as shown in FIG. 14, the tip 100A and the tip rail 300A first come into contact with each other at a part where the tip 100A and the tip rail 300A are close to each other (in this embodiment, the ends 300Ae1 and 300Ae2). Thereafter, a distance between the tip 100A and the tip rail 300A at the center 300Ac gradually decreases, and the tip 100A and the tip rail 300A finally come into contact with each other at the center 300Ac.

Therefore, the smaller an opening cross-sectional area is, the smaller a temporal variation of the opening cross-sectional area per unit time is. In other words, the smaller the largest distance between the tip 100A and the tip rail 300A, the smaller the temporal variation. Therefore, in the blowing part 1A, similarly to the blowing part 1, high-order harmonic components are less than high-order harmonic components in the blowing part using the reed 10Z, and a soft sound can be generated.

### [Third Embodiment]

FIG. 15 is a diagram showing a blowing part according to the third embodiment. A blowing part 1B includes a reed 10B, a mouthpiece 30B, and a ligature 80B. The ligature 80B is the same as the ligature 80. The reed 10B is substantially the same as the reed 10, and a bending of a tip 100B is smaller than that of the tip 100. The mouthpiece 30B is generally the same as the mouthpiece 30A, and a bending of a surface of the tip rail 300B is smaller than the bending of the surface of the tip rail 300A.

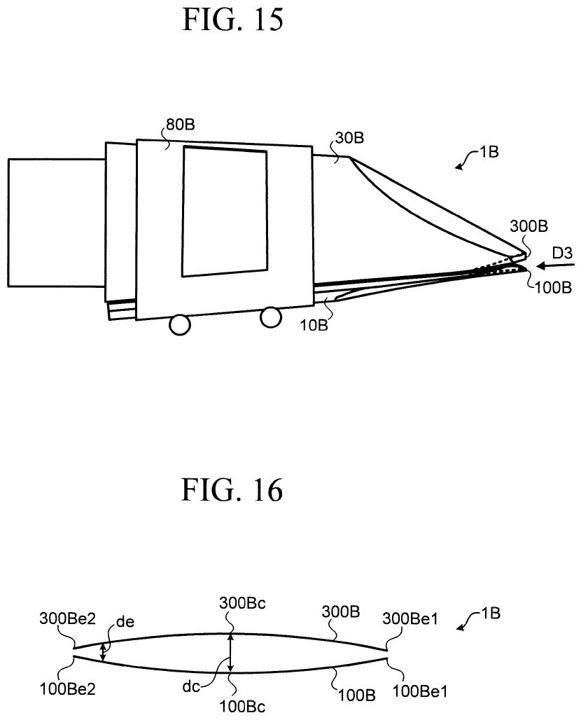

FIG. 16 is a diagram for explaining a relationship between the tip rail and the tip in the third embodiment. FIG. 16 shows a positional relation between the tip rail 300B and the tip 100B when the blowing part 1B is viewed from the tip in FIG. 15 (corresponding to a direction D3 in FIG. 15).

Also in the blowing part 1B, a distance dc between the tip 100B and the tip rail 300B at a center 100Bc of the tip 100B (a center 300Bc of the tip rail 300B) is the largest, and a distance de between the tip 100B and the tip rail 300B in a vicinity of ends 100Be1 and 100Be2 of the tip 100B (ends 300Be1 and 300Be2 of the tip rail 300B) is smaller than the distance dc. In other words, there are two positions where the distance between the tip 100B and the tip rail 300B differs from each other.

Since the tip 100B and the tip rail 300B have such positional relation, the smaller an opening cross-sectional area is, the smaller a temporal variation of the opening cross-sectional area per unit time is. In other words, the smaller the largest distance between the tip 100B and the tip rail 300B, the smaller the temporal variation. Therefore, in the blowing part 1B, similarly to the blowing part 1, high-order harmonic components are less than high-order harmonic components in the blowing part using the reed 10Z, and a soft sound can be generated.

### <Modifications>

The present disclosure is not limited to the embodiments described above, and includes various other modifications. For example, the embodiments described above have been described in detail for a purpose of showing the present disclosure in an easy-to-understand manner, and are not necessarily limited to those having all the described configurations. That is, part of the configuration of each embodiment may be replaced with another configuration or may be deleted. Some modifications will be described below. In the following description, although the first embodiment may be described as a modified example, the second embodiment or the third embodiment may also be applied as a modified example.

(1) In the blowing part 1 in a state where the reed 10 is attached to the mouthpiece 30, if there are two positions where the distance between the tip 100 and the tip rail 300 differs from each other, the relationship between the tip rail 300 and the tip 100 is not limited to the examples in the first embodiment to the third embodiment, and may have various relationships. Hereinafter, a plurality of modifications of the relationship between the tip rail 300 and the tip 100 will be described.

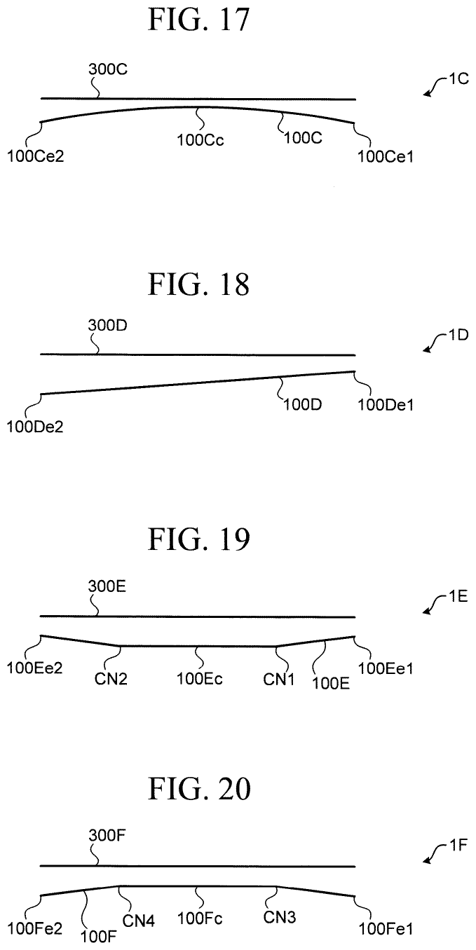

FIG. 17 to FIG. 24 are diagrams for explaining a relationship between a tip rail and a tip in each of modifications. Either diagram is a diagram corresponding to the timing (1) shown in FIG. 6. Tip rails 300C to 300K shown below are the same as the tip rail 300.

A tip 100C of a blowing part 1C shown in FIG. 17 includes a center 100Cc closest to the tip rail 300C and ends 100Ce1 and 100Ce2 farthest from the tip rail 300C. That is, a relationship between the center and the ends in the tip 100C is opposite to that in the tip 100 of the first embodiment. As described above, the portion having the smallest distance between the tip 100 and the tip rail 300 may not be the end of the tip, and the portion having the largest distance between the tip 100 and the tip rail 300 may not be the center of the tip 100.

A tip 100D of a blowing part 1D shown in FIG. 18 includes an end 100De1 closest to the tip rail 300D and an end 100De2 farthest from the tip rail 300D.

Like the tip 100D, a tip may not be symmetrical relative to a center, and only one of ends (the end 100De1 in this modification) may be positioned above the center. Further, the tip 100D is connected by a straight line between the end 100De1 and the end 100De2. As described above, the tip 100 is not limited to a case where both ends are connected by a curve, and may be connected by a straight line, or may be connected by a combination of a straight line and a curve.

A tip 100E of a blowing part 1E shown in FIG. 19 includes ends 100Ee1 and 100Ee2 closest to the tip rail 300E and a center 100Ec farthest from the tip rail 300E. In a vicinity of the center 100Ec, a distance between the tip 100E and the tip rail 300E does not vary, and the tip 100E and the tip rail 300E are parallel to each other. Three straight lines are connected between the end 100Ee1 and the end 100Ee2. A corner CN1 is formed between the center 100Ec and the end 100Ee1, and a corner CN2 is formed between the center 100E2 and the end 100Ee2.

A tip 100F of a blowing part 1F shown in FIG. 20 includes a center 100Fc closest to the tip rail 300F and ends 100Fe1 and 100Fe2 farthest from the tip rail 300F. In a vicinity of the center 100Fc, a distance between the tip 100F and the tip rail 300F does not vary, and the tip 100F and the tip rail 300F are parallel to each other. Similarly to the tip 100E, the tip 100F is connected between the end 100Fe1 and the end 100Fe2 by three straight lines. A corner CN3 is formed between the center 100Fc and the end 100Fe1 and a corner CN4 is formed between the center 100Fc and the end 100Fe2.

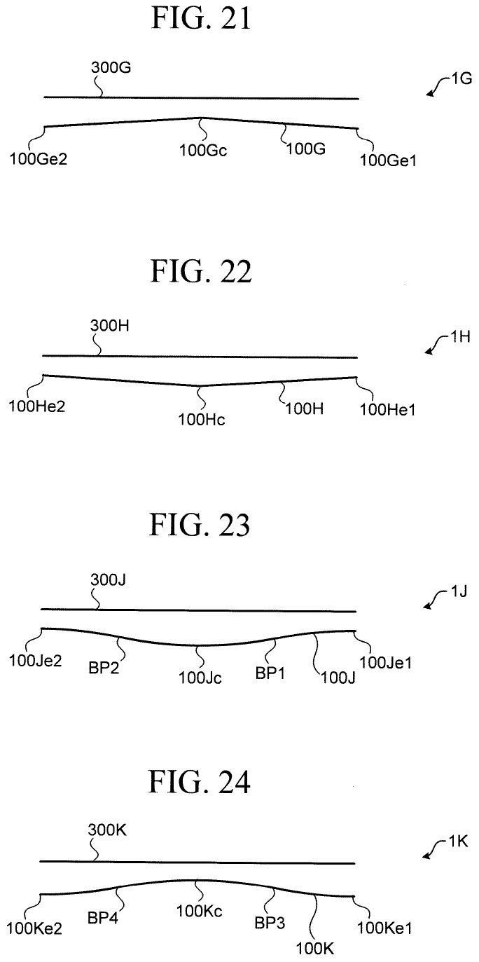

A tip 100G of a blowing part 1G shown in FIG. 21 includes a center 100Gc closest to the tip rail 300G and ends 100Ge1 and 100Ge2 farthest from the tip rail 300G. Two straight lines are connected between the end 100Ge1 and the end 100Ge2. The center 100Gc forms a corner connecting the two straight lines.

A tip 100H of a blowing part 1H shown in FIG. 22 includes ends 100He1 and 100He2 closest to the tip rail 300H and a center 100Hc farthest from the tip rail 300H. Similarly to the tip 100G, the tip 100H is connected between the end 100He1 and the end 100He2 by two straight lines. The center 100Hc forms a corner connecting the two straight lines.

As shown in FIG. 19 to FIG. 22, the tip 100 may have a configuration in which a plurality of straight lines are combined between both ends, such as the tips 100E, 100F, 100G, and 100H. The tip 100 may have a shape connected by a line in which a straight line and a curved line are combined between both ends.

A tip 100J of a blowing part 1J shown in FIG. 23 includes ends 100Je1 and 100Je2 closest to the tip rail 300J, and a center 100Jc farthest from the tip rail 300J. The end 100Je1 and the end 100Je2 are connected by a curve. An inflection point BP1 is formed between the center 100Jc and the end 100Je1, and an inflection point BP2 is formed between the center 100Jc and the end 100Je2.

A tip 100K of a blowing part 1K shown in FIG. 24 includes a center 100Kc closest to the tip rail 300K and ends 100Ke1 and 100Ke2 farthest from the tip rail 300K. The end 100Ke1 and the end 100Ke2 are connected by a curve. An inflection point BP3 is formed between the center 100Kc and the end 100Ke1, and an inflection point BP4 is formed between the center 100Kc and the end 100Ke2.

As shown in FIG. 23 and FIG. 24, the tip 100 may have a plurality of inflection points in a curve connecting both ends. The inflection point may be one. In this case, it is preferable that a portion located above the tips 100J and 100K, that is, a portion close to the tip rail 300J, is a curve that is convex upward.

For example, in the tip 100J shown in FIG. 23, a curve in a vicinity of the end 100Je1 and in a vicinity of the end 100Je2, that is, a curve on end sides from the inflection points BP1 and BP2 is convex upward (on the tip rail 300J side). With such a configuration, the tip 100J can be easily slipped on the tip rail 300J after the ends 100Je1 and 100Je2 of the tip 100J contact the tip rail 300J.

In the tip 100K shown in FIG. 24, a curve in a vicinity of the center 100Kc, that is, a curve between the inflection points BP3 and BP4 is convex upward (on the tip rail 300K side). With such a configuration, it is possible to realize gentle contact when the tip 100K and the tip rail 300K come into contact with each other.

(2) Although a plurality of examples regarding a shape of the tip 100 are described in the modification (1), the tip 100 and the tip rail 300 may be replaced as in a relationship between the first embodiment and the second embodiment. That is, a modification of the shape of the tip 100 can be applied as a modification of a shape of the tip rail 300. As in a relationship between the first embodiment and the third embodiment, a modification of the shape of the tip 100 can be applied as a modification of the shapes of both the tip 100 and the tip rail 300.

(3) The blowing part 1 is not limited to the case where the blowing part is configured to be attachable to and detachable from a wind instrument main body, and may be configured so as not to be attachable to and detachable from the wind instrument main body.

(4) The blowing part 1 may be used for an electronic wind instrument or the like.

(5) The blowing part 1 may be formed by integrally forming the reed 10 and the mouthpiece 30. In this case, the ligature 80 is not necessary.

What is claimed is:

1. A reed comprising:
a base part including a planar portion and a heel at a first end of the base part; and
a vamp extending from a second end of the base part, opposite the heel, the vamp having a sloping shape ending in a tip, which is inclined relative to the planar portion, when the vamp is viewed along a first direction from the first end to the second end of the base part with the planar portion facing upward.

2. The reed according to claim 1, wherein the sloping shape is such that an end of the tip is located above a center of the tip when the vamp is viewed along the first direction.

3. The reed according to claim 1, wherein the sloping shape is symmetrical with respect to the center of the tip when the vamp is viewed along the first direction.

4. The reed according to claim 1, wherein the sloping shape is such that a curve connects two ends of the tip when the vamp is viewed along the first direction.

5. The reed according to claim 4, wherein the curve has at least one inflection point.

6. The reed according to claim 1, wherein the sloping shape has a curve that is convex upward at its most upward point when the vamp is viewed along the first direction.

7. The reed according to claim 1, wherein a lowest portion of the tip is located above the planar portion when the vamp is viewed along the first direction.

8. The reed according to claim 7, wherein the base part and the vamp include a resin material.

9. A mouthpiece comprising:
a table;
a side rail extending from the table, the side rail having a first end and a second end opposite to the first end; and
a tip rail extending from the second end of the side rail,
wherein the first end of the side rail connects the table,
wherein the tip rail having a sloping shape inclined relative to the table, when the tip rail is viewed along a first direction from the first end to the second end of the side rail with the table facing upward.

10. The mouthpiece according to claim 9, wherein the sloping shape is such that an end of the tip rail is located above a center of the tip rail when the tip rail is viewed along the first direction.

11. The mouthpiece according to claim 9, wherein the sloping shape is symmetrical with respect to the center of the tip rail when the tip rail is viewed along the first direction.

12. The mouthpiece according to claim 9, wherein the sloping shape is such that a curve connects two ends of the tip rail when the tip rail is viewed along the first direction.

13. The mouthpiece according to claim 12, wherein the curve has at least one inflection point.

14. The mouthpiece according to claim 9, wherein the sloping shape has a curve that is convex upward at its most upward point when the tip rail is viewed along the first direction.

15. A blowing part comprising:
a reed including a tip; and
a mouthpiece including a tip rail,
wherein a first distance between the tip and the tip rail at a first position near a center of the tip along a width direction is different from a second distance between the tip and the tip rail at a second position near an end of the tip along the width direction.

16. The blowing part according to claim 15,
wherein the reed further includes a base part having a planar portion,
wherein the mouthpiece further includes a table, and
wherein the planar potion of the reed is in contact with the table.
